(19) United States
(12) Patent Application Publication
(10) Pub. No.: US 2026/0349630 A1
(43) Pub. Date: Nov. 5, 2026

(54) IMAGE FORMING APPARATUS AND CONTROL METHOD THEREFOR

(71) Applicant: CANON KABUSHIKI KAISHA, Tokyo (JP)

(72) Inventor: TOMOYA SATO, Kanagawa (JP)

(21) Appl. No.: 19/657,181

(22) Filed: Apr. 24, 2026

(30) Foreign Application Priority Data
May 2, 2025 (JP) 2025-076869

(51) Int. Cl. G06F 3/12

(52) U.S. Cl. CPC G06F 3/1205; G06F 3/1256; G06F 3/1258; G06F 2213/0042

(57) ABSTRACT

An image forming apparatus has a setting memory storing a setting of a continuous input restriction that restricts continuous operations within a predetermined time. The image forming apparatus determines whether or not the continuous input restriction is enabled, based on the setting stored in the setting memory, determines, when the continuous input restriction is determined to be enabled and an operation input by an input unit is received, whether or not it is a continuous operation within the predetermined time, determines, when the operation input is determined to be a continuous operation within the predetermined time, whether or not the operation input is an input from a predetermined input unit, and accepts the operation input when the operation input is determined to be an input from the predetermined input unit.

### BACKGROUND

### Field of the Technology

The present disclosure relates to an image forming apparatus and a control method therefor.

### Description of the Related Art

In recent years, accessibility of input operations has been attracting attention in various image forming apparatuses, and there is a demand for image forming apparatuses that are easy to use for all users regardless of whether they have disabilities.

For example, there are users who unintentionally press the same key continuously due to physical disabilities or the like. In order to enable even such users to operate the image forming apparatus without problems, some image forming apparatuses are equipped with a function that prevents acceptance of continuous inputs within a fixed time. In such an image forming apparatus, a "time for which continuous operations are not accepted" is made settable, and when continuous input operations are performed within the set time, control is performed to ignore those input operations. A function that ignores operations performed continuously in this manner is called a bounce key function.

For example, Japanese Patent Application Laid-Open No. 2017-84103 discloses an information processing apparatus that, when a first icon is touched, invalidates a nearby second icon for a predetermined time.

### SUMMARY

A technology of the present disclosure aims to improve user convenience in a case where a setting for not accepting continuous key operations is enabled.

According to one aspect of the present disclosure, an image forming apparatus, comprising: a setting memory storing a setting of a continuous input restriction that restricts continuous operations within a predetermined time; at least one memory storing instructions; and at least one processor that is in communication with the at least one memory and that, when executing the instructions, cooperates with the at least one memory to execute processing, the processing including determining whether or not the continuous input restriction is enabled, based on the setting stored in the setting memory; determining, when the continuous input restriction is determined to be enabled and an operation input by an input unit is received, whether or not it is a continuous operation within the predetermined time; determining, when the operation input is determined to be a continuous operation within the predetermined time, whether or not the operation input is an input from a predetermined input unit; and accepting the operation input when the operation input is determined to be an input from the predetermined input unit is provided.

According to the above configuration, user convenience is improved in a case where a setting for not accepting continuous key operations is enabled.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a hardware configuration diagram of an image forming apparatus 101.

FIG. 2 is a software configuration diagram of the image forming apparatus 101.

FIG. 3 is a diagram schematically representing a configuration of personal setting data.

FIG. 4 is a diagram showing an example of a login screen displayed on a display/operation unit 207 of the image forming apparatus 101.

FIG. 5A is a diagram showing an example of a home screen displayed on the display/operation unit 207 of the image forming apparatus 101 (display language is Japanese).

FIG. 5B is a diagram showing an example of a home screen displayed on the display/operation unit 207 of the image forming apparatus 101 (display language is English).

FIG. 6 is a diagram showing an example of a setting screen for continuous input restriction displayed on the display/operation unit 207 of the image forming apparatus 101.

FIG. 7 is a flowchart explaining processing of the image forming apparatus in a first embodiment.

FIG. 8 is a flowchart explaining processing of the image forming apparatus in a second embodiment.

FIG. 9 is a diagram showing an example of a confirmation screen for continuous input restriction displayed on the display/operation unit 207 of the image forming apparatus 101.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In an image forming apparatus supporting a bounce key function, the application target of the bounce key function is not limited to input operations via physical keys or a touch panel provided in the image forming apparatus. In addition to these, the bounce key function is also applied to inputs from an external input device such as a keyboard connected to the image forming apparatus via a USB interface.

On the other hand, there are cases where a barcode reader is connected to the image forming apparatus via a USB interface, and a barcode is read to input a telephone number or the like. The barcode reader analyzes the read barcode and continuously transmits it to the image forming apparatus as key codes. Since the input from the barcode reader becomes continuous inputs over a short time, there is a problem that the input will no longer be accepted if the bounce key function is enabled. This problem has similarly occurred for other input devices such as an OCR reader connected via USB, as long as it is an input device in which a plurality of continuous key codes are input in response to one user operation.

The present disclosure has been made in view of the above issues. That is, an object is to provide an image forming apparatus that, even if a setting for not accepting continuous key operations is enabled, can take input as accepted regarding an input from an input device in which a plurality of continuous key codes are input in response to one user operation.

### Hardware of Image Forming Apparatus

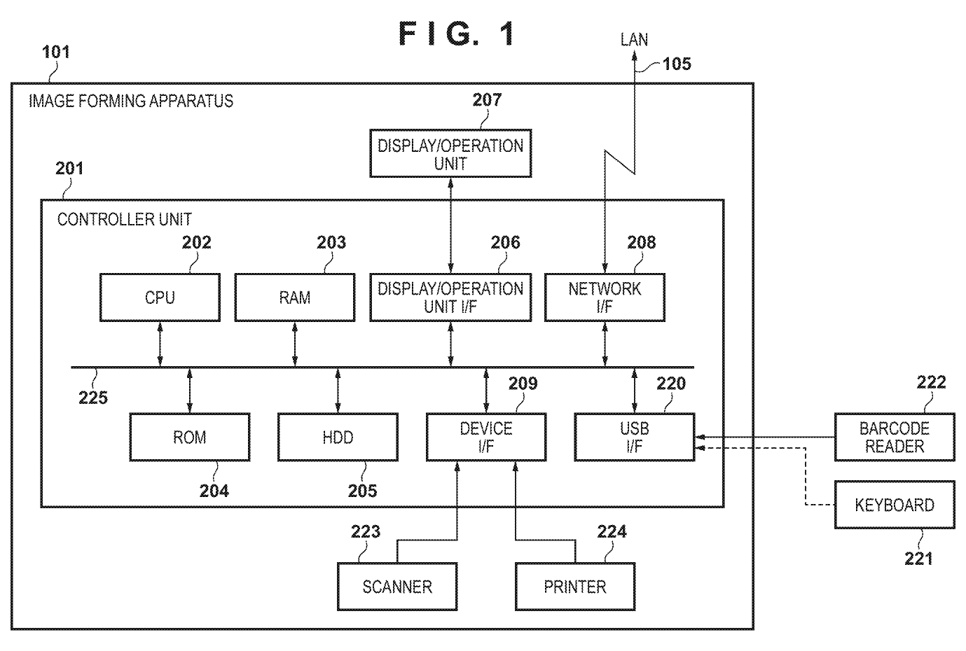

FIG. 1 is a hardware configuration diagram of the image forming apparatus 101 according to the present embodiment. In a controller unit 201 within the image forming apparatus 101, a CPU 202 is a calculation device that controls the entire system. The CPU 202 comprehensively controls each device connected to a system bus 225. A ROM 204 is a non-volatile memory and stores image data, other data, and various programs for the CPU 202 to operate, and the like.

A RAM 203 is a volatile memory and is used as a temporary storage area such as a main memory and a work area of the CPU 202. Also, programs and data such as an operating system, system software, and application software are also arranged in the RAM 203.

The CPU 202 controls each part of the image forming apparatus 101 by loading programs stored in the ROM 204 or the like into a memory such as the RAM 203 and executing them. Note that the programs for the CPU 202 to operate are not limited to those stored in the ROM 204, and those stored in advance in a hard disk drive (HDD) 205 or the like may be used.

The hard disk drive (HDD) 205 stores the operating system, system software, application software, image data, setting data, and the like. The stored software may include a driver program for driving a device such as a barcode reader connected via a universal serial bus (USB) interface. Note that other storage devices such as an SSD, an SD memory card, or an eMMC may be used as long as data can be stored.

A display/operation unit I/F 206 is an interface unit with the display/operation unit 207, and outputs information to be displayed on the display/operation unit 207 to the display/operation unit 207. Also, it accepts information input by a user from the display/operation unit 207. The display/operation unit 207 includes physical keys and a touch panel for accepting user operations.

A network I/F 208 connects to a network (LAN) 105 and performs communication with PCs, other image forming apparatuses, and the like connected on the same LAN.

A device I/F 209 connects a scanner 223 and a printer 224, which are image input/output devices, with the controller unit 201, and performs input and output of image data. That is, it prints image data on paper, performs scanning of a document, and the like.

A USB I/F 220 is an interface unit with an external USB device, and performs input and output of data with an external USB device such as a barcode reader 222. The barcode reader 222 is a device that optically reads one-dimensional or two-dimensional barcodes. The barcode reader 222 notifies the USB I/F 220 of the read data as a continuous key code string corresponding to the data. Time intervals of the input continuous key codes may be fixed time intervals, and in a setting of a continuous input restriction (so-called bounce key function) described later, a time longer than these fixed time intervals can be set as a time for which continuous inputs are not accepted.

In addition to the barcode reader 222, a keyboard 221 or the like that can also be connected to a general PC can be connected to the USB I/F 220. When the keyboard 221 is connected, operations become easier even on screens where input operations are difficult with operations using the physical keys and the touch panel included in the display/operation unit 207, particularly for inputting character strings and the like.

The keyboard 221 and the barcode reader 222 are selectively connected to the image forming apparatus 101 and used as necessary.

### Software of Image Forming Apparatus

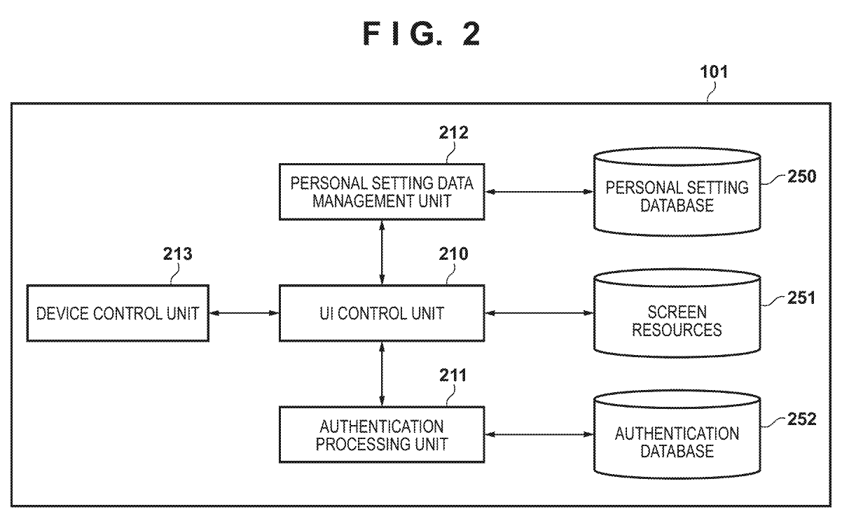

FIG. 2 is a software configuration diagram of the image forming apparatus 101. The image forming apparatus 101 includes software modules such as a UI control unit 210, an authentication processing unit 211, a personal setting data management unit 212, and a device control unit 213. Each of these software modules is stored in any storage means of the RAM 203, the ROM 204, and the HDD 205, and is executed by the CPU 202. Also, personal setting data 250, screen resources 251, and authentication data 252 are stored in a predetermined storage unit (RAM 203, ROM 204, HDD 205) of the image forming apparatus 101. Note that the software shown in FIG. 2 is software related to the continuous input restriction of the present embodiment.

A UI control unit 210 performs input/output control processing for the display/operation unit 207 of the image forming apparatus 101. Specifically, the UI control unit 210 receives operation information performed by the user using the physical keys and the touch panel of the display/operation unit 207, and operation information performed by the user using the barcode reader 222 or the keyboard 221. At this time, the UI control unit 210 also performs a judgment as to whether or not operation input was performed continuously, and whether or not to invalidate the input when operations were performed continuously. Specifically, the UI control unit 210 acquires a user authentication result from an authentication processing unit 211, and if login is successful, reads out the personal setting data of the corresponding user from a personal setting database 250 via a personal setting data management unit 212. Then, the UI control unit 210 performs processing to judge whether continuous input operation is enabled or disabled (that is, whether continuous input restriction is disabled or enabled) based on the read personal setting data. Details will be described later.

Then, the UI control unit 210 generates an operation screen based on the received operation information and information notified from a device control unit 213, the authentication processing unit 211, and the like, and causes the display/operation unit 207 to display the generated screen via the display/operation unit I/F 206. Specifically, it reads out necessary screen resources 251, and generates a screen by arranging the read resources.

The authentication processing unit 211 is invoked from the UI control unit 210 when authentication processing is necessary, and performs authentication processing. Specifically, when called from the UI control unit 210, it is passed an ID and password information for authentication. The authentication processing unit 211 performs authentication processing by collating authentication information including the passed ID and password with authentication information in an authentication database 252, and returns an authentication result to the UI control unit 210. The UI control unit 210 generates a screen based on the authentication result. Note that authentication information such as the ID and password for authentication may be input by the user using the physical keys and the touch panel of the display/operation unit 207, or may be acquired from an IC card or the like.

The personal setting data management unit 212 manages personal setting data of users who use the image forming apparatus 101. Specifically, the personal setting data management unit 212 stores personal setting data in the personal setting database 250 in association with a user ID according to an instruction from the UI control unit 210. Also, the personal setting data management unit 212 reads out personal setting data associated with a user ID from the personal setting database 250 and returns it to the UI control unit 210 according to an instruction from the UI control unit 210 or the like.

The device control unit 213 is called from the UI control unit 210 and controls each part of the image forming apparatus 101. Specifically, it operates the scanner 223 and the printer 224 via the device I/F 209 to perform control of jobs such as copy, print, and scan.

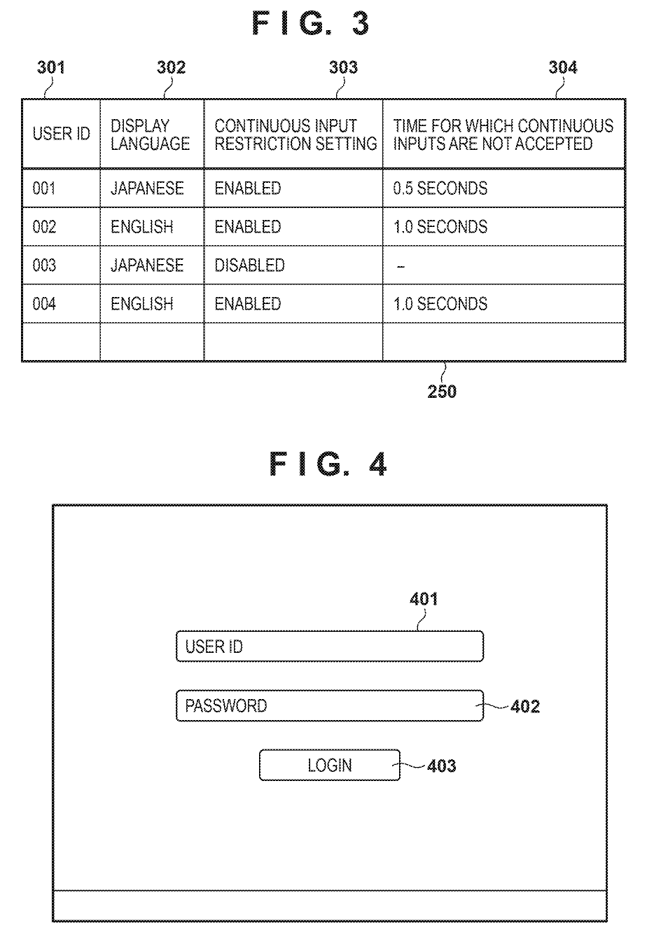

FIG. 3 is a diagram schematically representing a configuration of the personal setting database 250. The personal setting database 250 is setting information that can be held for each user among settings for the image forming apparatus 101. The personal setting database 250 has information of settings for each of a display language 302, continuous input restriction 303, and a time setting for which continuous inputs are not accepted 304, and these are stored in association with a user ID 301.

The display language 302 is a setting of the display language of the screen to be displayed on the display/operation unit 207. The continuous input restriction 303 is a setting of whether or not to perform control to invalidate continuous inputs within a set time. The time setting for which continuous inputs are not accepted 304 is a setting of a time for which continuous inputs are invalidated when the continuous input restriction 303 is enabled. For example, in the example of FIG. 3, for a user with user ID 001, it is set so as not to accept operations performed continuously within 0.5 seconds from a previous operation. Note that in the present embodiment, continuous input refers to continuously pressing the touch panel or a physical key within a predetermined time. Continuous input may be limited to continuous pressing of the same key. Alternatively, continuous input may be limited to continuous pressing of the same key or adjacent keys. The personal setting data shown in FIG. 3 is an example, and other information may be included. Also, it may include setting values of a device not associated with a specific user. The setting values of the device may be applied to operations by a user who is not logged in.

### Example of User Interface

FIG. 4 is a diagram showing an example of a login screen displayed on the display/operation unit 207 of the image forming apparatus 101. In a case where user authentication is operated, the login screen shown in FIG. 4 is displayed when the image forming apparatus 101 is started. The login screen includes a user ID input area 401 and a password input area 402. When each area is pressed (or touched) by the user, a virtual keyboard screen (not shown) is invoked. The user inputs a user ID and a password using the displayed virtual keyboard. When a login button 403 is pressed, authentication processing is performed. Authentication processing is performed by the authentication processing unit 211 collating with the authentication data based on the input user ID and password.

Note that for user authentication, an IC card or the like may be used, or biometric authentication may be used, instead of having the user input the user ID and password.

When user authentication is successful, the UI control unit 210 generates an operation screen such as a home screen and displays it on the display/operation unit 207 of the image forming apparatus 101. When generating the operation screen, the UI control unit 210 passes the user ID of the logged-in user to the personal setting data management unit 212, reads out setting information of the display language 302 of the user, and generates the operation screen in that language.

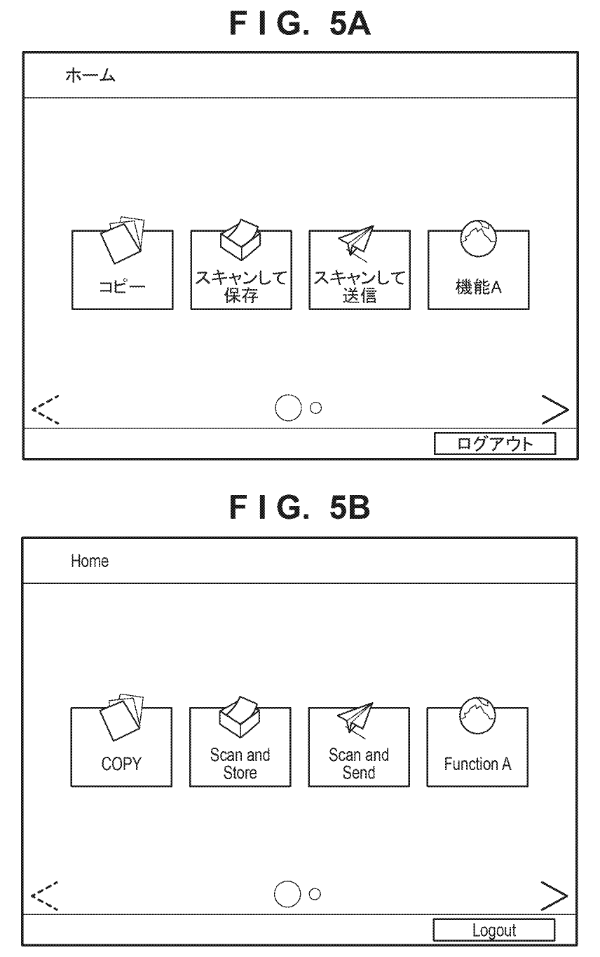

FIGS. 5A and 5B are diagrams showing examples of a home screen displayed on the display/operation unit 207 when a user has logged in. FIG. 5A is a screen displayed when a user whose display language is set to "Japanese" (for example, a user with user ID: 001) logs in. FIG. 5B is a screen displayed when a user whose display language is set to "English" (for example, a user with user ID: 002) logs in.

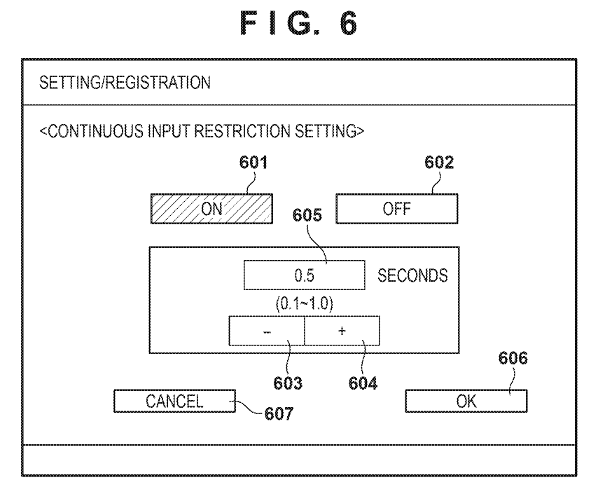

FIG. 6 is a diagram showing an example of a setting screen for continuous input restriction displayed on the display/operation unit 207 of the image forming apparatus 101. This screen is invoked by a user operation after the user logs in to the image forming apparatus. For example, when a menu button (not shown) is selected from the home screen of FIG. 5B, a menu screen including items of setting/registration is displayed accordingly, and the screen of FIG. 6 may be displayed in response to setting/registration being selected there.

An ON button 601 is a button to be pressed when enabling continuous input restriction, and an OFF button 602 is a button to be pressed when disabling continuous input restriction. Selection of the ON button 601 and the OFF button 602 is mutually exclusive. When the ON button 601 is in the selected state, a minus button 603 and a plus button 604 become enabled, and a value in a setting display area 605 for the time for which continuous inputs are not accepted can be increased or decreased. When an OK button 606 is pressed, the personal setting data of the user is updated with the set content and this screen is closed. When a cancel button 607 is pressed, this setting screen is closed without changing the setting. The time over which continuous inputs are not accepted can be set in predetermined steps within a range of settable time. In the example of FIG. 6, the range of settable time is a range from 0.1 seconds to 1.0 second, and the step is, for example, 0.1 seconds.

For example, a user whose hands shake due to a physical disability of the upper limbs or the like and who often unintentionally hits buttons repeatedly may invoke this screen and set the continuous input restriction to enabled.

### Input Processing Procedure

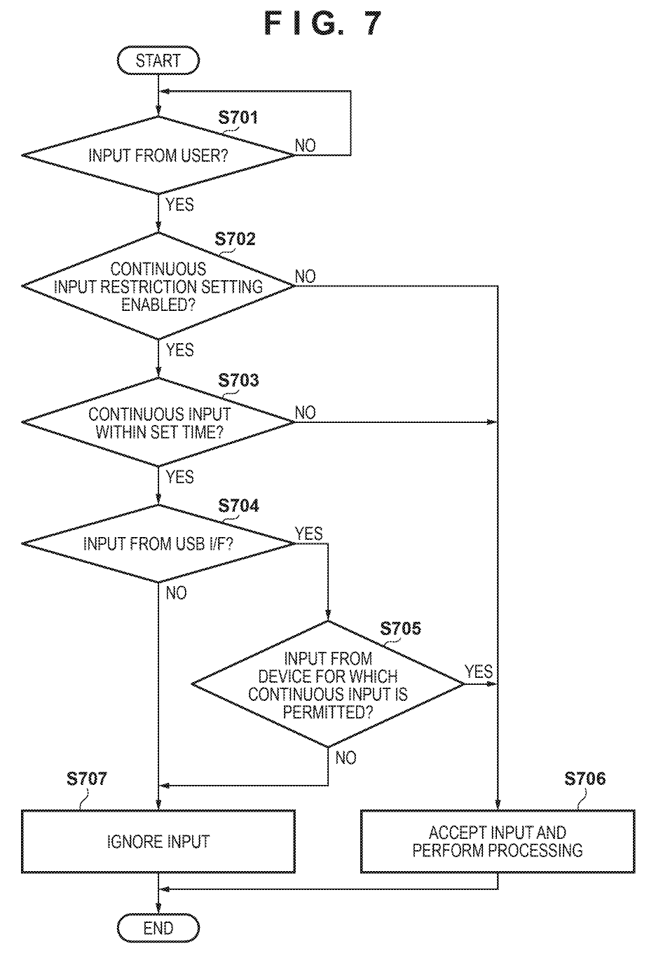

FIG. 7 is a diagram explaining operation processing in a case of executing an input operation using a physical key or a touch panel of the display/operation unit 207, or an external USB device (the barcode reader 222 or the keyboard 221) in the first embodiment.

Processing from step S701 to step S707 is processing realized by the CPU 202 of the image forming apparatus 101 executing programs stored in a memory, and processing is started with an input from the user in step S701 as a trigger.

First, in step S701, the CPU 202 judges whether there is an input from the user. The input from the user includes inputs from the physical keys and the touch panel provided in the display/operation unit 207, or inputs by an external USB device (the barcode reader 222 or the keyboard 221). When the user operates a physical key, the touch panel, or an external USB device, the input signal is notified from the display/operation unit I/F 206 or the USB I/F 220 to the CPU 202 via the system bus 225. When the CPU 202 receives the input signal, it judges that there was an input from the user, and proceeds with processing to step S702.

In step S702, the CPU 202 judges whether or not the setting of the continuous input restriction is enabled. Specifically, the CPU 202 causes processing of the personal setting data management unit 212 to operate, and reads out the setting value of the "continuous input restriction 303" of the currently logged-in user from the personal setting database 250. Note that in a state where there is no logged-in user, a setting value of the device not associated with a specific user is read out. If the setting of the continuous input restriction is enabled, the CPU 202 proceeds with processing to step S703. On the other hand, if the setting of the continuous input restriction is not enabled, the CPU 202 proceeds with processing to step S706.

In step S703, the CPU 202 judges whether or not it is a continuous input within the set time. Specifically, first, the CPU 202 measures an elapsed time from the previous input. Furthermore, it causes processing of the personal setting data management unit 212 to operate, and reads out the setting value of the "time setting for which continuous inputs are not accepted 304" of the currently logged-in user from the personal setting data 250. The read setting value and the elapsed time from the previous input are compared, and if the elapsed time from the previous input is shorter, it is judged to be a continuous input within the set time. If it is judged to be a continuous input within the set time, the CPU 202 proceeds with processing to step S704. On the other hand, if it is judged not to be a continuous input within the restricted time, the CPU 202 proceeds with processing to step S706.

In step S704, the CPU 202 judges whether or not it is an input from the USB I/F. If it is judged to be an input from the USB I/F, the CPU 202 proceeds with processing to step S705. On the other hand, if it is judged not to be an input from the USB I/F, the CPU 202 proceeds with processing to step S707.

In step S705, the CPU 202 judges whether or not it is an input from a device for which continuous input is permitted. Specifically, identification information (vendor ID and product ID) identifying a device connected to the USB I/F is acquired from the USB device. Then, by comparing the acquired identification information with an identification information list held in the image forming apparatus, it is judged whether or not the connected device is a device for which continuous input is permitted. The identification information list is one in which vendor IDs and product IDs of devices for which continuous input is permitted are listed, and is stored in a predetermined storage unit (RAM 203, ROM 204, HDD 205) of the image forming apparatus 101. Note that the identification information list may be held in advance in the image forming apparatus, or may be made registerable by the user. Also, instead of holding the identification information list of devices for which continuous input is permitted in the image forming apparatus, a query may be made to another device on the network. The method of judging whether or not continuous input is permitted for a device is not limited to the above means. Depending on settings of the USB device connected to the USB I/F, a specific key code may be sent at the start of input and the end of input, and a judgment of whether it is an input from a device for which continuous input is permitted may be made according to that key code.

As the device for which continuous input is permitted, there is, for example, a device in which a plurality of key codes are continuously input in response to one user operation, such as a barcode reader connected via a USB interface. Also, as a device for which continuous input is not permitted, there is, for example, a device in which one key code is input in response to one user operation, such as a keyboard or a touch panel.

Note that the device for which continuous input is permitted is not limited to a barcode reader. For example, it may be an OCR reader (optical character recognition reader) or the like that applies optical character recognition (OCR) to an image captured by a camera and notifies an extracted character string as key codes.

If it is judged in step S705 to be an input from a device for which continuous input is permitted, the CPU 202 proceeds with processing to step S706. On the other hand, if it is judged not to be an input from a device for which continuous input is not permitted, the CPU 202 proceeds with processing to step S707.

In step S706, the CPU 202 accepts the input and performs processing according to the received input. Specifically, it generates an operation screen according to the received input, and causes the display/operation unit 207 to display the generated screen via the display/operation unit I/F 206. Also, it notifies the device control unit 213 and the authentication processing unit 211 to request processing. The input accepted in step S706 is one key code or a plurality of continuous key codes according to the read barcode or characters, if the input device is a barcode reader, an OCR reader, or the like connected via a USB interface.

Meanwhile, in step S707, the CPU 202 ignores the received input. That is, it judges that it is a continuous input within the set time, and does not execute processing for the received input.

By the above processing, for example, even if the user with user ID 001 who has the continuous input restriction set to "enabled" unintentionally hits the same key repeatedly within the set time due to their hands shaking during input using a physical key of the display/operation unit 207, the continuous input is ignored. For this reason, the same processing is not executed twice. On the other hand, content read with the barcode reader 222 is input as continuous key codes, but the input processing as read is executed without the input being ignored.

In this way, even if continuous input restriction is enabled, by applying the setting according to the input device, input in line with the user's intention can be realized.

### Second Embodiment

In the first embodiment, an example was shown in which, when there is an input from a user, it is judged whether or not it is an input from a device for which continuous input is permitted. In a second embodiment, an example is shown in which, when a user logs in to the image forming apparatus, it is judged whether or not a USB device is connected to the image forming apparatus 101, and the user is prompted to confirm. Note that the configuration of the image forming apparatus 101 may be similar to that of the first embodiment.

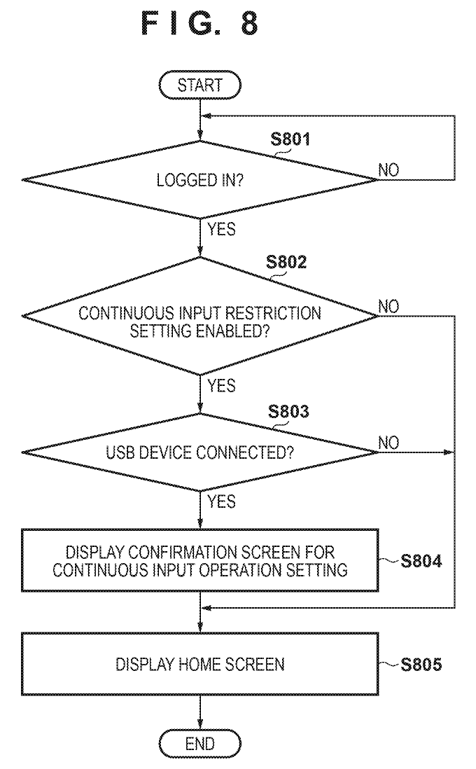

FIG. 8 is a diagram explaining operation processing when a user logs in to the image forming apparatus 101 in the second embodiment. Processing from step S801 to step S805 is processing realized by the CPU 202 of the image forming apparatus 101 executing programs stored in a memory.

First, in step S801, the CPU 202 judges whether the user has logged in. Specifically, the user ID and password input to a login screen such as that shown in FIG. 4 are collated with the authentication database 252, and if there is a matching user ID and password, it is judged that the user has logged in. When it is judged that the user has logged in, the CPU 202 proceeds with processing to step S802.

In step S802, the CPU 202 judges whether or not the setting of the continuous input restriction is enabled. Specifically, the CPU 202 causes processing of the personal setting data management unit 212 to operate, and reads out the setting value of the "continuous input restriction 303" of the currently logged-in user from the personal setting database 250. If the setting of the continuous input restriction is enabled, the CPU 202 proceeds with processing to step S803. On the other hand, if the setting of the continuous input restriction is not enabled, the CPU 202 proceeds with processing to step S805.

In step S803, the CPU 202 judges whether or not a USB device is connected to the image forming apparatus 101. Specifically, a connection status with respect to the USB I/F 220 is confirmed. If it is judged that a USB device is connected, the CPU 202 proceeds with processing to step S804. On the other hand, if a USB device is not connected, the CPU 202 proceeds with processing to step S805.

In step S804, the CPU 202 displays a confirmation screen for the continuous input restriction.

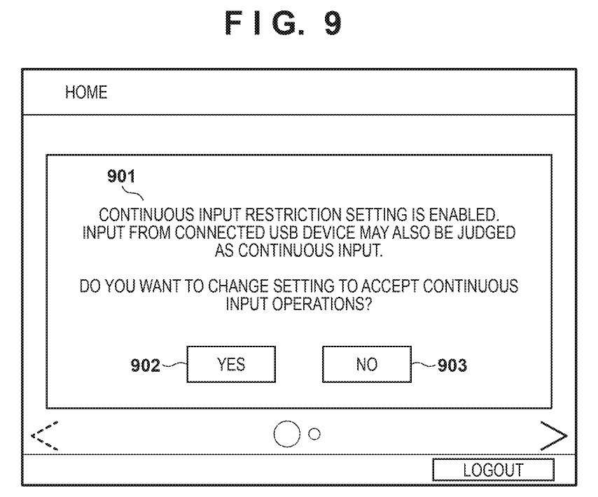

FIG. 9 is an example of the confirmation screen for the continuous input restriction displayed in step S804. A message 901 is a message notifying that if the current setting remains as it is, input from a USB device may also be restricted as continuous input. A yes button 902 is a button to be pressed when changing the setting of the continuous input restriction, and when pressed, the setting screen for the continuous input restriction shown in FIG. 6 is displayed. When a no button 903 is pressed, the processing proceeds to step S805 without changing the setting of the continuous input restriction. In the setting screen for the continuous input restriction, the user can turn off the continuous input restriction. By turning off the continuous input restriction, continuous key codes input from a barcode reader or the like connected via a USB interface can be input without being hindered.

In step S805, the CPU 202 displays a home screen. Specifically, it passes the user ID of the logged-in user to the personal setting data management unit 212, reads out the setting information of the display language 302 of the user, generates an operation screen in that language, and displays a home screen such as that shown in FIGS. 5A or 5B according to the setting of the display language.

According to the second embodiment above, when a user logs in, if a USB device is connected, a confirmation screen for continuous input restriction is displayed to notify the user that input from the USB device may be restricted as continuous input. Therefore, the user will not perform erroneous operations or become confused without noticing that continuous input is restricted.

Note that instead of displaying the confirmation screen for continuous input restriction if a USB device is connected when the user logs in, the confirmation screen for continuous input restriction may be displayed at a timing when a USB device is connected.

Also, the first embodiment and the second embodiment may be combined, so that processing of FIG. 8 is executed when there is a login by a user, and furthermore, processing of FIG. 7 is executed when there is an operation input by the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076869, filed May 2, 2025 which is hereby incorporated by reference herein in its entirety.

What is claimed is:

1. An image forming apparatus, comprising:
a setting memory storing a setting of a continuous input restriction that restricts continuous operations within a predetermined time;
at least one memory storing instructions; and
at least one processor that is in communication with the at least one memory and that, when executing the instructions, cooperates with the at least one memory to execute processing, the processing including
determining whether or not the continuous input restriction is enabled, based on the setting stored in the setting memory;
determining, when the continuous input restriction is determined to be enabled and an operation input by an input unit is received, whether or not it is a continuous operation within the predetermined time;
determining, when the operation input is determined to be a continuous operation within the predetermined time, whether or not the operation input is an input from a predetermined input unit; and
accepting the operation input when the operation input is determined to be an input from the predetermined input unit.

2. The image forming apparatus according to claim 1, wherein
the predetermined input unit continuously inputs a plurality of key codes in response to one operation by a user.

3. The image forming apparatus according to claim 1, wherein
the predetermined input unit is a barcode reader connected via a predetermined interface.

4. The image forming apparatus according to claim 3, wherein
the predetermined interface is a universal serial bus.

5. The image forming apparatus according to claim 1, wherein
the predetermined input unit is an optical character recognition reader connected via a predetermined interface.

6. The image forming apparatus according to claim 1, wherein
the setting memory stores a setting of a continuous input restriction that restricts continuous operations within a predetermined time for each user, and
the processing includes determining whether or not the continuous input restriction is enabled for each logged-in user.

7. The image forming apparatus according to claim 1, wherein
the processing includes, when the continuous input restriction is enabled and an operation input by an input unit is received, not accepting the operation input when it is determined that it is a continuous operation within the predetermined time and that the operation input is not an input from the predetermined input unit.

8. The image forming apparatus according to claim 1, wherein
determination of whether or not the operation input by the input unit is an input from the predetermined input unit is based on identification information of the input unit.

9. The image forming apparatus according to claim 1, wherein
the setting memory further stores the predetermined time over which continuous operations are restricted.

10. A non-transitory computer-readable storage medium storing a program that, when loaded into and executed by a computer, causes the computer to execute processing, the processing comprising:
determining whether or not continuous input restriction is enabled, based on a setting of the continuous input restriction that restricts continuous operations within a predetermined time and is stored in a memory of the computer;
determining, when the continuous input restriction is determined to be enabled and an operation input by an input unit is received, whether or not it is a continuous operation within the predetermined time;
determining, when the operation input is determined to be a continuous operation within the predetermined time, whether or not the operation input is an input from a predetermined input unit; and
accepting the operation input when the operation input is determined to be an input from the predetermined input unit.

11. A control method for an image forming apparatus having a memory, comprising:
accepting, by an input unit, an operation input by a user;
determining whether or not continuous input restriction is enabled, based on a setting of the continuous input restriction that restricts continuous operations within a predetermined time and is stored in the memory;
determining, when the continuous input restriction is determined to be enabled and the operation input by the input unit is received, whether or not it is a continuous operation within the predetermined time;
determining, when the operation input is determined to be a continuous operation within the predetermined time, whether or not the operation input is an input from a predetermined input unit; and
accepting the operation input when the operation input is determined to be an input from the predetermined input unit.

12. An image forming apparatus, comprising:
a setting memory storing a setting of a continuous input restriction that restricts continuous operations within a predetermined time;
a display;
at least one memory storing instructions; and
at least one processor that is in communication with the at least one memory and that, when executing the instructions, cooperates with the at least one memory to execute processing, the processing including
determining whether or not the continuous input restriction is enabled, based on the setting stored in the setting memory;
determining, when the continuous input restriction is determined to be enabled, whether or not a predetermined input unit that accepts an operation input by a user is connected; and
displaying, by the display, a screen including a message indicating that the continuous input restriction is enabled when it is determined that the predetermined input unit is connected.

13. The image forming apparatus according to claim 12, wherein
the screen further includes an operation unit for causing a screen for changing the setting of the continuous input restriction stored in a storage means to be displayed.

14. The image forming apparatus according to claim 12, wherein
the predetermined input unit is an input unit in which a plurality of key codes are continuously input in response to one operation by a user.

15. The image forming apparatus according to claim 12, wherein
the predetermined input unit is an input device connected via a universal serial bus.

16. A non-transitory computer-readable storage medium storing a program that, when loaded into and executed by a computer, causes the computer to execute processing, the processing comprising:
determining whether or not a continuous input restriction is enabled, based on a setting of the continuous input restriction that restricts continuous operations within a predetermined time and is stored in a memory of the computer;
determining, when the continuous input restriction is determined to be enabled, whether or not a predetermined input unit that accepts an operation input by a user is connected; and
displaying, by a display, a screen including a message indicating that the continuous input restriction is enabled when it is determined that the predetermined input unit is connected.

17. A control method for an image forming apparatus having a memory and a display, comprising:
determining whether or not a continuous input restriction is enabled, based on a setting of the continuous input restriction that restricts continuous operations within a predetermined time and is stored in the memory;
determining, when the continuous input restriction is determined to be enabled, whether or not a predetermined input unit that accepts an operation input by a user is connected; and
displaying, by the display, a screen including a message indicating that the continuous input restriction is enabled when it is determined that the predetermined input unit is connected.
